(19) United States
(12) Patent Application Publication
(10) Pub. No.: US 2014/0047759 A1
(43) Pub. Date: Feb. 20, 2014

(54) Bug catching device

(71) Applicants: Charles Almy, Charlottesville, VA (US); Katharine C. Almy, Charlottesville, VA (US)

(72) Inventors: Charles Almy, Charlottesville, VA (US); Katharine C. Almy, Charlottesville, VA (US)

(21) Appl. No.: 13/573,026

(22) Filed: Aug. 15, 2012

(51) Int. Cl. A01M 3/00

(52) U.S. Cl. 43/134

(57) ABSTRACT

A bug Catching Device with a hollow housing having a sides, a housing lid, one or more thin walled extension tubes and one or more additional thin walled extension tubes. The housing lid has an upwardly directed collar for holding an extension tube and a downwardly directed collar that extends down one inch. The housing lid is screwed onto the housing. A tip member integral with the tube or is a separate member inserted into the end of the extension tube. The user scrapes a bug off a surface with the tip member causing the bug to slide down into the housing and to be unable to escape the housing. Additional extension tubes can be added for reaching high locations.

### CROSS REFERENCE TO RELATED APPLICATIONS

Not Applicable

### STATEMENT REGARDING FEDERALLY SPONSORED RESEARCH OR DEVELOPMENT Not Applicable

### DESCRIPTION OF ATTACHED APPENDIX

Not Applicable

### BACKGROUND OF THE INVENTION

The invention relates generally to the field of bug-catching devices. It is a hand-held bug-catching device with extension tube(s), tip attachments, and a tube end cap. This invention allows the user to take an active role in eradicating nuisance bugs from his/her environment, putting the power squarely in the hands of the user. With this device in hand, the user becomes a natural predator.

Insects of various types frequently find their way into homes and commercial buildings, where they are unwelcome guests. Certain nuisance insects transition indoors en masse, seeking refuge from cold winter temperatures and emerging in spring to feed, mate, and lay eggs. The Brown Marmarated Stink Bug [BMSB] is one such over-wintering invader. A relative newcomer to North America, the BMSB was accidentally introduced from Asia, thought to have stowed away in packing crates. Known as an agricultural pest in its native range of China, Japan, Korea, and Taiwan, the BMSB has become a serious pest of fruit, vegetables, and farm crops in the United States. The BMSB has spread rapidly across the country since its arrival in Allentown, Pa., in 1996. A strong flyer and a hitchhiker in vehicles, the BMSB quickly migrated to adjoining Maryland, West Virginia, and New Jersey, as well as north to New York. Today, the MBSB has invaded over 30 states ranging from Maine to Mississippi across to Ohio and west to California, Oregon, and Washington State. Without a natural predator capable of stemming the tide, the MBSB population is exploding exponentially. In an effort to combat the MBSB's autumn movement indoors, people have employed a variety of techniques—from sealing cracks around windows and doors and repairing damaged screens to hiring professional exterminators—and devices, like vacuum cleaners and fly swatters, which are only somewhat successful.

Although standard bug-catching methods work to some degree, they can tend to be cumbersome, complicated, time-consuming, costly, and ineffective. For example, vacuum cleaners do suck up Stink Bugs, but users must either dispose of cleaner bags immediately or tolerate the lingering odor emitted by the still alive—Stink Bugs inside. Pesticides are poisonous and pose a risk to human health, as well as to pets and other living things. They are generally ineffective against Stink Bugs and are not recommended. There are insecticide products available for external use at points of entry, but they degrade quickly in sunlight and should be applied by a licensed pest control operator at some expense. Using insecticides indoors can kill hundreds of stink bugs, but their carcasses attract other, destructive pests like carpets beetles and mice.

The primary goal of the invention is to manage the BMSB infestation and to provide an inexpensive, eco-friendly, and effective Stink Bug catching device that enables the user to capture the BMSB easily and efficiently, while avoiding the necessity of direct contact with the bug and the foul smell it emits when threatened. The Stink Bug drops into the tube and slides down into the bottle, unable to escape back up the tube. If the goal is to exterminate the bug, pour a small quantity of rubbing alcohol into the bottle or a solution of your choice. If the goal is to capture bugs for observation, forego a kill solution.

### BRIEF SUMMARY OF THE INVENTION

The primary object of the invention is to provide an inexpensive stink bug catching device that allows a person to easily capture and store unwanted bugs without touching the bug and thereby avoiding getting the stink smell that they extrude onto the hands and fingers.

Another object of the invention is to provide a bug catching device that allows a person to capture bugs in hard to reach places on walls, ceilings and other hard to reach places such as the corners of rooms.

Another object of the invention is to provide a bug catching device that allows a person to capture the invasive bug from exterior walls, windows or doors in an effort to capture the bug before it enters the house

Another object of the invention is to provide a bug catching device that includes one or more extension tubes to allow the catching of bugs in hard to reach areas.

A further object of the invention is to provide a bug catching device that includes attachment tips that are customized for scooping bugs off ceilings, walls or the corners of a room.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed bug catching device comprising: a hollow housing having a sides, an integral bottom and a cylindrical top aperture, a housing lid, a first thin walled extension tube, one or more additional thin walled extension tubes, a tube to tube connector, a flat ended tip member, a rounded end tip member, a creased end tip member, said lid having an upwardly extending collar and a downwardly extending collar, said upwardly extending collar capable of receiving said extension tube, said downwardly extending collar extending one inch, said housing lid capable of being screwed onto the mating threads surrounding said housing aperture, said extension tube being approximately one and one quarter inch in diameter, said hollow housing being approximately three inches tall and two inches wide, said additional extension tube capable of being frictionally connected to said first extension tube by said tube to tube connector, said tip members each constructed of thin die cut plastic sheet material, said die cut plastic tip members capable of being frictionally inserted into the distal end of said extension tube, said flat ended tip member capable of scraping a bug off of a flat wall or ceiling, said creased end tip member capable of scraping a bug off of the corner of a room, said rounded end tip member capable of scraping a bug off of an irregular surface said bug caused to involuntarily slide down said extension tube and into said hollow housing, said bug, unable to climb back up said thin walled extension tube, being trapped in said hollow housing until disposed of by the user.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in use

FIG. 2 is a side section view of the invention.

FIG. 3 is a perspective view of the straight tip.

FIG. 4 is a perspective view of the creased tip.

FIG. 5 is a perspective view of the curved tip.

FIG. 6 is a perspective view of a single tube design with the mitered tip in the use position.

FIG. 7 is a perspective view of the single tube design with the flat tip in the use position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

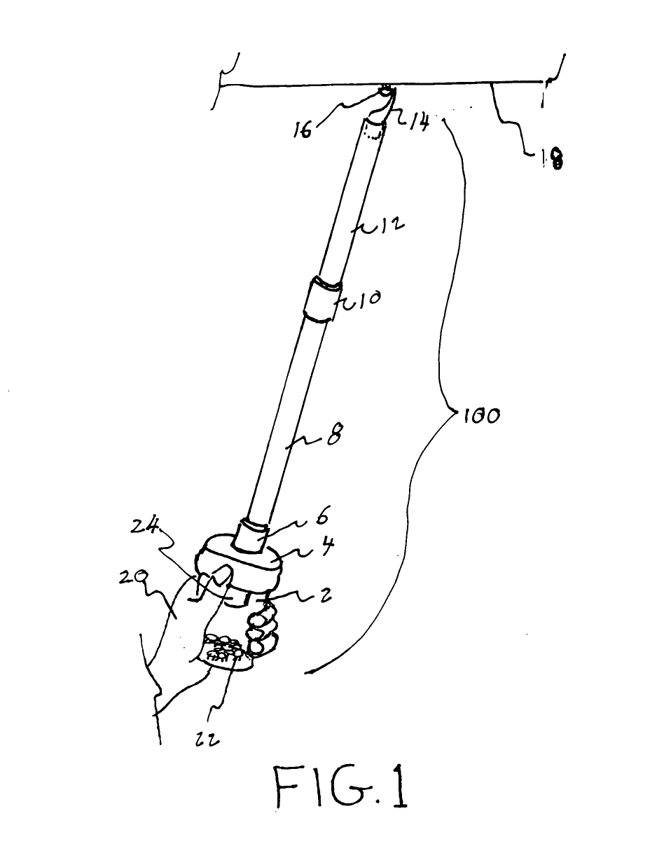

Referring now to FIG. 1 we see a perspective view of a person 20 using the bug catcher of the present invention 100. The person 20 is holding a bottle or housing 2 that includes side walls and an integral bottom panel that holds approximately four ounces and is approximately two and one half inches in diameter, and three inches tall. This is an ideal shape for holding comfortably in one's hand 20. The bottle cap or lid 4 includes an integral upwardly facing collar 6 and a downwardly facing collar 24. The upwardly facing collar frictionally and slidably retains a length of rigid thin walled tubing 8. An additional length of tubing 12 can be added to the first length 8 by means of connector collar 10. In this way, the user can reach high locations such as a ceiling or a high location on a wall.

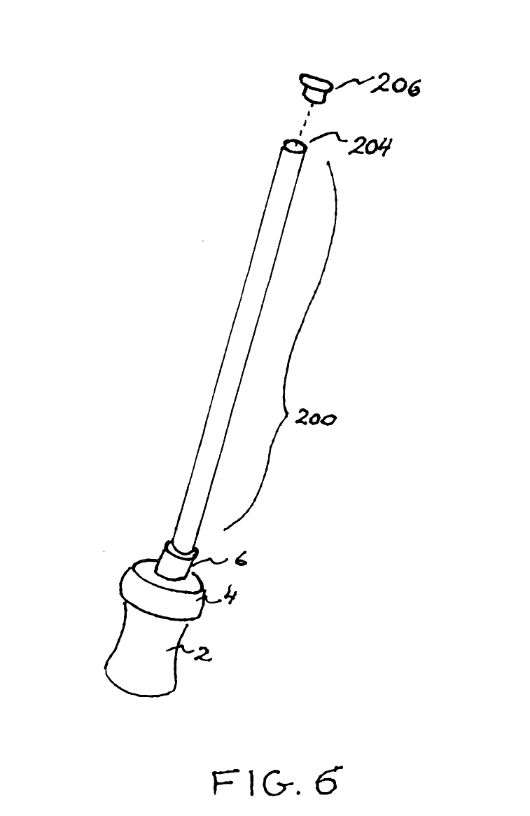

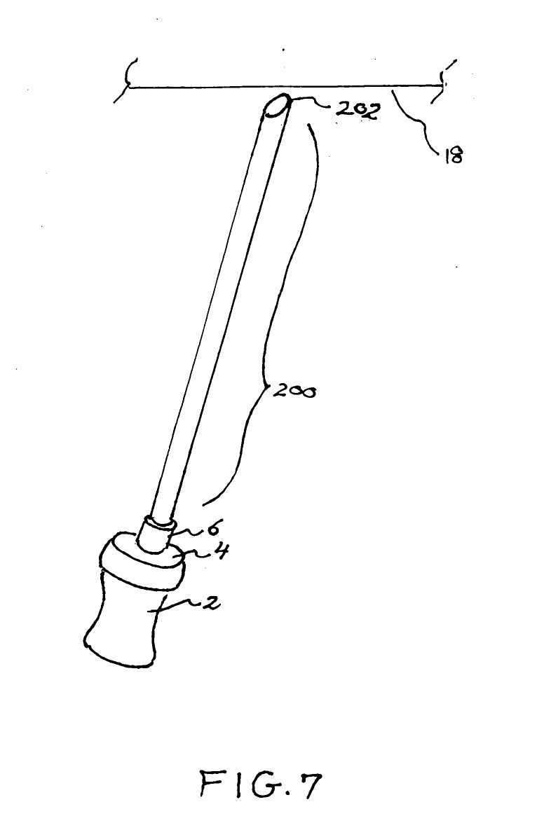

Alternately, a single long tube 200 as shown in FIG. 7 can be used thereby avoiding the need to connect two tubes together .Figure 6 shows an integral flat tip 204. However the tube 200 can be reversed as shown in FIG. 7 where the end of the tube 200 is cut at an angle 202 to reach into corners and other hard to reach locations. FIG. 6 also shows an optional cap member 206 that can be plugged into the end of tip 204 so that any bugs which may reside in the tube 200 will not be able to exit the tube when the user is finished using the invention 100 and wishes to store it for use at a later date.

Referring back to FIG. 1, in another embodiment, a separate tip member 14, is die cut from of a resilient plastic sheet material such as 0.020″ polycarbonate and is placed in the end of tube 12 and held in by frictional means. In another embodiment, the tip member 14 may be a rigid injection molded piece that frictionally engages the end of tube 12. Tip 14 includes a flat edge that allows the user to coax a bug 16 off of a wall or ceiling 18 and for the bug to drop into the bottle 2 where it is trapped with its fellow bugs 22. Alternately, the tube end itself can be cut at an angle, thereby avoiding the need for a secondary tip.

The lid 4 includes an integral downward facing collar 24 that extends into the bottle 2 approximately one inch. A specific bug, called a stink bug, is found in at least 30 states in the United States and the present invention is designed specifically to catch these type of bugs. Experiments have shown that once these type of bugs land in the bottle 2, they are unable to exit the bottle because they can not successfully negotiate the lower lip of the downward facing collar 24.

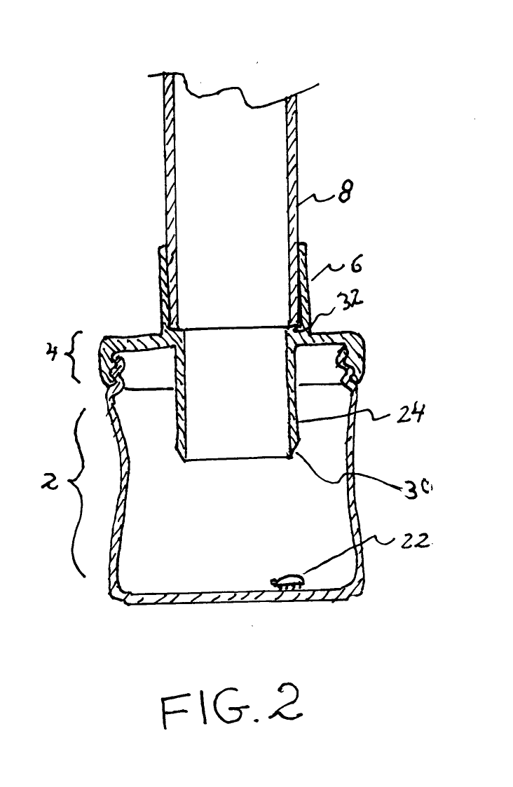

FIG. 2 shows a section view that bisects the lower portion of the invention 100. The downwardly facing collar 24 includes a mitered lip the increases the difficulty of the bug 22 from crawling around the lip 30. The first tube 8 is shown slid into collar 6. The tube 8 is prevented from traveling further into bottle 2 by contact with ledge 32. The integral nature of cap 4, collar 6 and collar 24 creates a sturdy structure for holding extension tube 8 as well as fixing the length of downward tube 24 to approximately one inch. The cap 4 can unscrew from bottle 2 to remove trapped bugs 22. The tubes 8, 12 can be made to various lengths depending on the intended use. For someone with very tall ceilings, the user can install an additional connector piece 10 and an additional extension piece 12 to reach high places on a wall or ceiling.

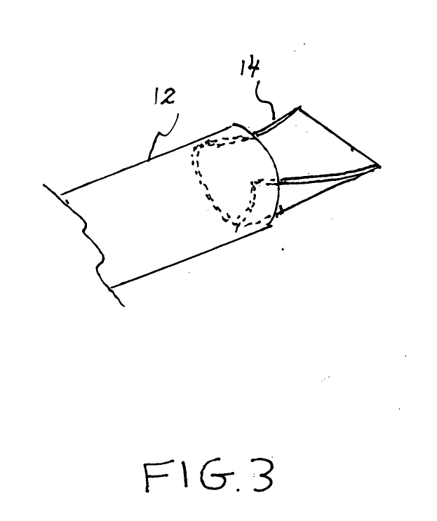

FIG. 3 shows a first type of tip 14 intended to coax bugs off of flat surfaces such as walls and ceilings.

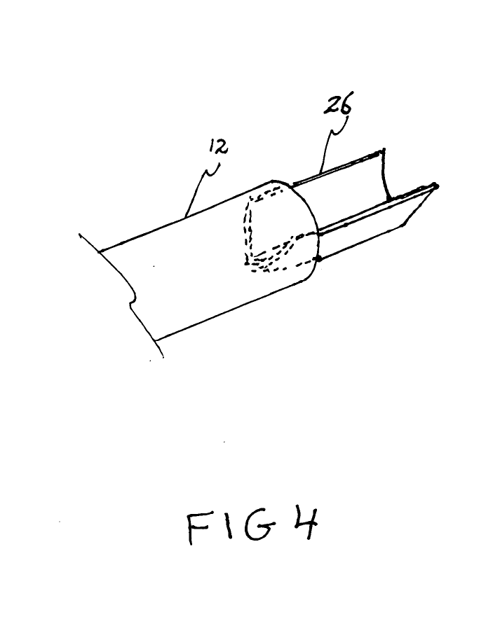

FIG. 4 shows a second type of tip 26 that has a ninety degree crease and can be used to dislodge bugs that are in the corner.

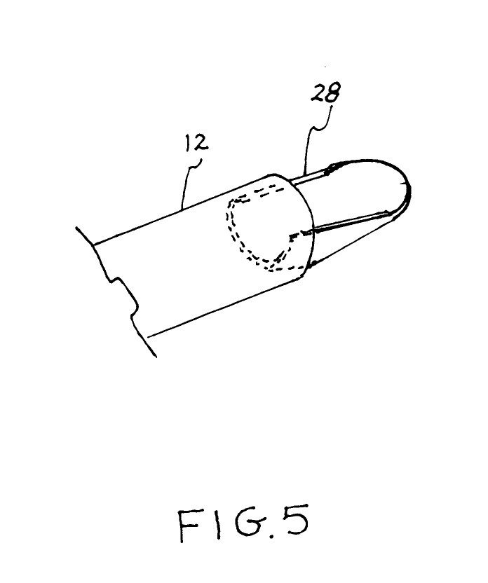

FIG. 5 shows a third type of tip 28 that can has a radial front edge that can dislodge bugs that are on an irregular surface.

The entire invention 100 is very economical to manufacture so that a low retail selling price can be obtained. The tubes 8, 12 can be removed for compact shipping and storage purposes. The invention 100 is a practical, useful and novel tool for the catching and storing of bugs, particularly those known as stink bugs.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Bug Catching Device comprising:
a hollow housing having a sides, an integral bottom and an cylindrical top aperture;
a housing lid;
a first thin walled extension tube;
one or more additional thin walled extension tubes;
one or more tube to tube connector members;
a flat ended tip member;
a rounded end tip member;
a creased end tip member;
said housing lid capable of being screwed onto said housing aperture;
said lid having an integral centrally located upwardly directed collar and an integral centrally located downwardly directed collar;
said downwardly facing collar extending down approximately one inch;
said extension tube being approximately one and one quarter inch in diameter;
said extension tube frictionally and slidably attached to said upwardly directed collar;
said additional extension tube connected to said first extension tube via said connector member;
said hollow housing being approximately three inches tall and two inches wide;
said tip members constructed of thin resilient die cut plastic sheet material;
said die cut plastic tip members capable of being frictionally inserted into the distal end of said extension tube;
said flat ended tip member capable of scraping a bug off of a flat wall or ceiling;
said creased end tip member capable of scraping a bug off of the corner of a room;
said rounded end tip member capable of scraping a bug off of an irregular surface;
said bug caused to involuntarily slide down said extension tube and into said hollow housing;
said bug, unable to climb back up said downwardly directed collar and being trapped in said hollow housing until disposed of by the user.

2. A bug catching device as claimed in claim 1 wherein an alternate embodiment includes an injection molded tip capable of slidably inserting onto the end of said extension tube.

3. A bug catching device as claimed in claim 1 wherein an alternate embodiment includes a tube tip that is integral with the tube and where one end of the tube includes a flat tip and the opposite end of the tube includes an angled tip.

4. A bug catching device as claimed in claim 1 further comprising a cap member capable of closing the end of said tube tip when said bug catching device is ready to be stored after use.
